(19) United States
(12) Patent Application Publication
(10) Pub. No.: US 2011/0115248 A1
(43) Pub. Date: May 19, 2011

(54) Protective Joint Frame of Baby Buggy

(76) Inventor: Eric CHEN, Guangdong (CN)

(21) Appl. No.: 12/693,448

(22) Filed: Jan. 26, 2010

(30) Foreign Application Priority Data
Nov. 18, 2009 (CN) 200910193975.X

(51) Int. Cl. B60J 7/08

(52) U.S. Cl. 296/107.09

(57) ABSTRACT

The invention discloses a protective joint frame for an inventive buggy, comprising: a hinge mount, a fixed bar connecting with the hinge mount and a folding bar, characterized in that, on the said hinge mount, there is another hinge joint connected with the said folding bar via a link mechanism. The hinge joint can slide on the folding bar and can cover the protective cover of exposed notch of the said hinge mount when the said folding bar is rotated; by adding a protective cover that moves with the folding bar, whereby the folding bar rotates, the protective cover is then driven to rotate so as to cover the gap between the bar and hinge groove; in such a manner, the baby cannot poke his/her fingers in, and thus to prevent the damage occurrence.

### BACKGROUND OF THE INVENTION

The invention relates to a baby buggy, particularly to a protective joint frame of a buggy.

In existing technology, baby buggies are usually equipped with a joint frame: a fixed bar is attached to a hinge mount, and the mount is slotted with a groove, in the groove a rotary folding bar is placed, and can be folded in the groove; a gap appears between the groove and folding bar of joint hinge as the folding bar rotates and leaves the hinge mount. In case that the baby's finger is placed in the said gap, and the folding bar just rotates to move down, the finger will then be injured and harm will happen to the baby.

### BRIEF SUMMARY OF THE INVENTION

Targeting to the initially-mentioned defects, the invention intends to provide a protective joint frame of baby buggy, for which, in any case, the folding bar rotates, and will never hurt your baby.

To provide a protective joint frame for an inventive buggy, it shall include a hinge mount, a fixed bar connecting with the hinge mount and a folding bar, characterized in that, on the said hinge mount, there is another hinge joint connected with the said folding bar via a link mechanism. The hinge joint can slide on the folding bar and can cover the protective cover of exposed notch of the said hinge mount when the said folding bar is rotated.

The principal advantages over this invention are shown below: by adding a protective cover that moves with the folding bar, whereby the folding bar rotates, the protective cover is then driven to rotate so as to cover the gap between the bar and hinge groove; in such a manner, the baby cannot poke his/her fingers in, and thus to prevent the damage occurrence.

### BRIEF DESCRIPTION OF THE DRAWINGS

FIG. 1 shows a diagrammatic side view of the frame of this invention;

FIG. 2 shows a structure diagram of joint frame of this invention in an unfolded state;

FIG. 3 shows a structure diagram of joint frame of this invention in a half-folded state;

FIG. 4 shows a structure diagram of joint frame of this invention in a folded state;

### DETAILED DESCRIPTION OF THE INVENTION

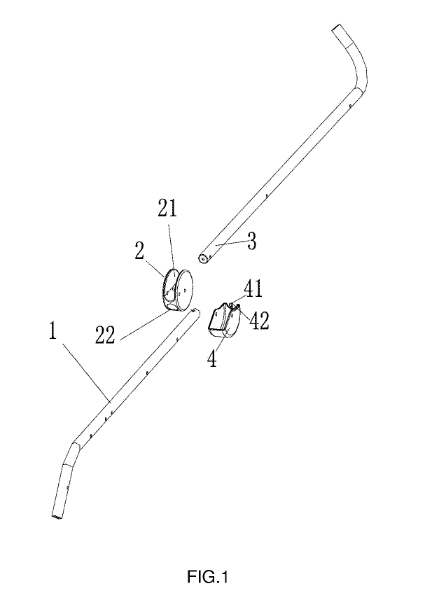

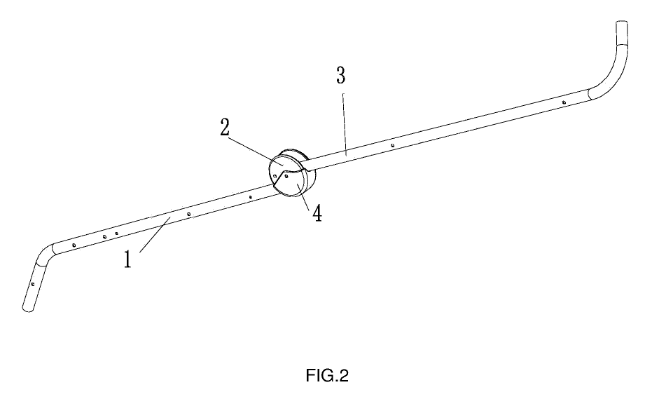

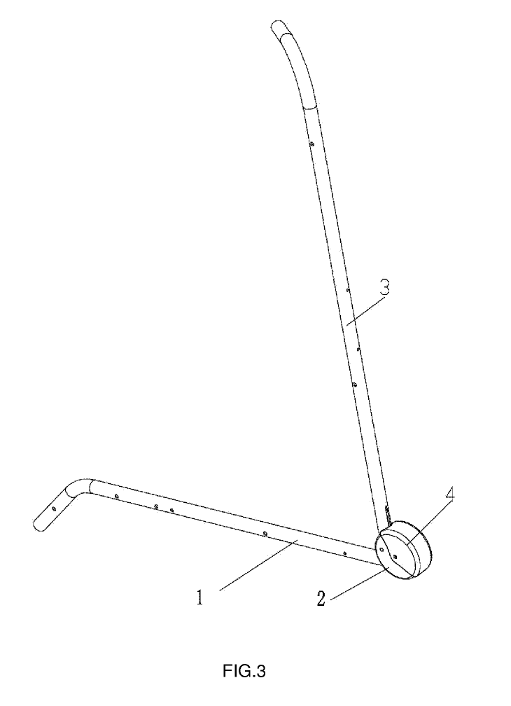

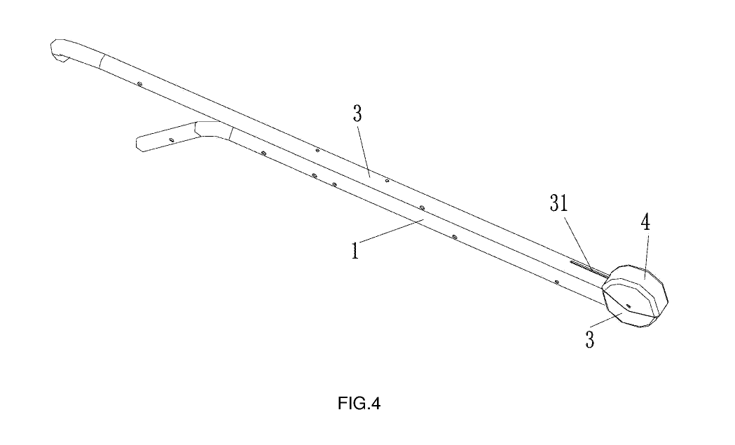

Embodiment 1: FIG. 1, FIG. 2, FIG. 3 and FIG. 4 show a kind of protective joint frame of an inventive buggy. The hinge mount 2 can be the circular or semi-circular shaped hinge mount; the fixed bar 1 is mounted in hole 22 under the said circular hinge mount 2; the said folding bar 3 is mounted in the groove 21 over the said circular hinge mount 3; the protective cover 4 is semicircular arc-shaped cover 4 wrapped around the said hinge mount 2; the link mechanism is arranged by opening a sliding groove 32 on longitudinal folding bar 3; a sliding pin 41 is mounted on the top of said protective cover 4, which can slide in the sliding groove 32; a notch 42 is opened at the end of protective cover 4 dovetailing with the folding bar 3. While the folding bar 3 rotates, the protective cover 4 is then driven to rotate so as to cover the gap between the bar and hinge groove 32.

Embodiment 2:FIG. 1, FIG. 2, FIG. 3 and FIG. 4 show a kind of protective joint frame of an inventive buggy. The hinge mount 2 is a circular hinge mount, the hole 22 under it is mounted with the fixed bar 1, and the groove 21 over it is mounted with the folding bar 3; the protective cover 4 is a semicircular arc-shaped cover wrapped around said hinge mount 2; the link mechanism is a sliding bushing (not shown in Figure) mounted at the end of said protective cover 4, and slides on the folding bar 3; a notch 42 is opened at the end of protective cover 4 dovetailing with the folding bar 3, the protective cover 4 is then driven to rotate so as to cover the gap between the bar and hinge groove.

In the above embodiments, the center of rotation of folding bar 3 and protective cover 4 can be designed to coincident frame, namely the eccentric settings; the coincident frame also can be adopted at the center of rotation of folding bar 3 and protective cover 4, yet the disadvantage for it is that as the diameter and size of protective cover 4 may increase, and hence, when the folding bar 3 rotates, both of these two frames are able to drive the protective cover 4 to rotate.

I claim:

1. A protective joint frame of baby buggy, consisting of a hinge mount, a fixed bar connecting with the hinge mount and a folding bar, characterized in that, on the said hinge mount, there is another hinge joint connected with the said folding bar via a link mechanism; the hinge joint can slide on the folding bar and can cover the protective cover of exposed notch of the said hinge mount when the said folding bar is rotated.

2. The protective joint frame of baby buggy according to claim 1, characterized in that the said hinge mount is in circular shape, the said fixed bar is fixed in the hole under the circular hinge mount, and the said folding bar is fixed in the groove over is the circular hinge mount, the said protective cover is a semicircular arc-shaped cover wrapped around the said hinge mount, the said link mechanism is a sliding pin set at the end of the protective cover, and provided with a sliding groove on folding bar in longitudinal direction, it can slide in the said sliding groove, a notch, dovetailing with the folding bar, is set at the end of protective cover.

3. The protective joint frame of baby buggy according to claim 1, characterized in that the said hinge mount is in circular shape, the said fixed bar is fixed under the said circular hinge mount, and the said folding bar is fixed over the said circular hinge mount; the protective cover is a semicircular arc-shaped cover wrapped around said hinge mount; the said link mechanism is a sliding bush mounted at the end of said protective cover, and can slide on the folding bar, a notch, dovetailing with the folding bar, is set at the end of protective cover.

4. The protective joint frame of baby buggy according to claim 2 or 3, characterized in that the rotation center of the said folding bar and the rotation center of the said protective cover is eccentrically-arranged.

5. The protective joint frame of baby buggy according to claim 2 or 3, characterized in that the rotation center of the said folding bar and the rotation center of the said protective cover coincides.
